(19) United States
(12) Patent Application Publication
(10) Pub. No.: US 2014/0025925 A1
(43) Pub. Date: Jan. 23, 2014

(54) PROCESSOR AND CONTROL METHOD THEREOF

(71) Applicant: FUJITSU LIMITED, Kawasaki-shi (JP)

(72) Inventor: YUJI KONDO, Kawasaki (JP)

(21) Appl. No.: 13/907,971

(22) Filed: Jun. 3, 2013

(30) Foreign Application Priority Data
Jul. 19, 2012 (JP) 2012-160696

(51) Int. Cl. G06F 15/80

(52) U.S. Cl. CPC G06F 15/80
USPC 712/30

(57) ABSTRACT

An processor includes: multiple arithmetic processing sections to execute arithmetic processing; and multiple registers provided for the multiple arithmetic processing sections. A register value of a register of the multiple registers corresponding to a given one of the multiple arithmetic processing sections is changed if program execution by the given one of the multiple arithmetic processing sections reaches a predetermined location in a program, and priorities of the arithmetic processing sections are dynamically determined in response to register values of the registers.

### CROSS-REFERENCE TO RELATED APPLICATIONS

This application is based upon and claims the benefit of priority of the prior Japanese Priority Application NO. 2012-160696 filed on Jul. 19, 2012, the entire contents of which are hereby incorporated by reference.

### FIELD

The embodiments discussed herein are related to an processor and a control method thereof.

### BACKGROUND

As the number of cores in a single-chip multiprocessor increases year by year, many-core processors, which include multiple cores in a processor, have been developed. When using a many-core processor, there are cases in which a non-negligible variation of job progress among the cores occurs due to unequal access times from the cores to shared resources, access conflict, the jitters, and the like, even if the cores are treated equivalently in software.

To synchronize the multiple cores, for example, barrier synchronization may be used. When execution of a program on one of the cores reaches a location where a barrier synchronization instruction is inserted beforehand in the program, the core stops the execution of the program until execution on the other cores reaches the corresponding barrier synchronization instruction. Such a synchronization with barrier synchronization or the like is established when the last core comes to the barrier location. Similarly, the program running on the multiple cores completes its execution when the last core completes its operation. Therefore, a variation of progress on program execution among the cores induces an increase of required computation time or reduced parallelization efficiency. Moreover, the increase of required computation time or the reduced parallelization efficiency may get even worse when the number of cores increases.

A progress variation caused by hardware is affected with non-reproducible factors such as execution timing and the like. Consequently, it is difficult for an application programmer to take these hardware related factors into account when programming an application. For that reason, it is desirable to use a hardware mechanism that can adjust progress speed of cores responsively to the situation of program execution to reduce a progress variation among the cores. Such a hardware mechanism is desirable also because it can make a synchronization less affected if workload imbalance among the cores arises, which may not be avoided by software.

### PATENT DOCUMENTS

PATENT DOCUMENT 1: Japanese Laid-open Patent Publication No. 2007-108944
PATENT DOCUMENT 2: Japanese Laid-open Patent Publication No. 2001-134466

### SUMMARY

According to an aspect of the embodiments, an processor includes: multiple arithmetic processing sections to execute arithmetic processing; and multiple registers provided for the multiple arithmetic processing sections. A register value of a register of the multiple registers corresponding to a given one of the multiple arithmetic processing sections is changed if program execution by the given one of the multiple arithmetic processing sections reaches a predetermined location in a program, and priorities of the arithmetic processing sections are dynamically determined in response to register values of the registers.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 is a schematic view illustrating an example of a configuration of an processor according to an embodiment;

FIG. 2 is a schematic view illustrating reduction of a progress variation by setting priority based on register values in progress management registers;

FIG. 3 is an example of a program executed by a core;

FIG. 4 is a flowchart illustrating an example of an operation of the processor in FIG. 1;

FIG. 5 is a schematic view illustrating an example of a state in which a fastest core reaches a first management point;

FIG. 6 is a schematic view illustrating an example of a state in which a second fastest core reaches the first management point;

FIG. 7 is a schematic view illustrating an example of a state in which a slowest core reaches the first management point;

FIG. 8 is a schematic view illustrating an example of changes of register values in the progress management registers;

FIG. 9 is a schematic view illustrating an example of a shared resource allocation mechanism in a shared bus arbitration unit;

FIG. 10 is a schematic view illustrating an example of a configuration of a prioritizing device;

FIG. 11 is a schematic view illustrating an example of cache way allocation based on priority;

FIG. 12 is a schematic view illustrating an example of cache way allocation based on priority;

FIG. 13 is a schematic view illustrating an example of cache way allocation based on priority; and

FIG. 14 is a schematic view illustrating an example of cache way allocation based on priority.

### DESCRIPTION OF EMBODIMENTS

In the following, embodiments will be described with reference to the accompanying drawings.

According to at least one of the embodiments, an processor is provided with a hardware mechanism that reduces a progress variation among arithmetic processing sections.

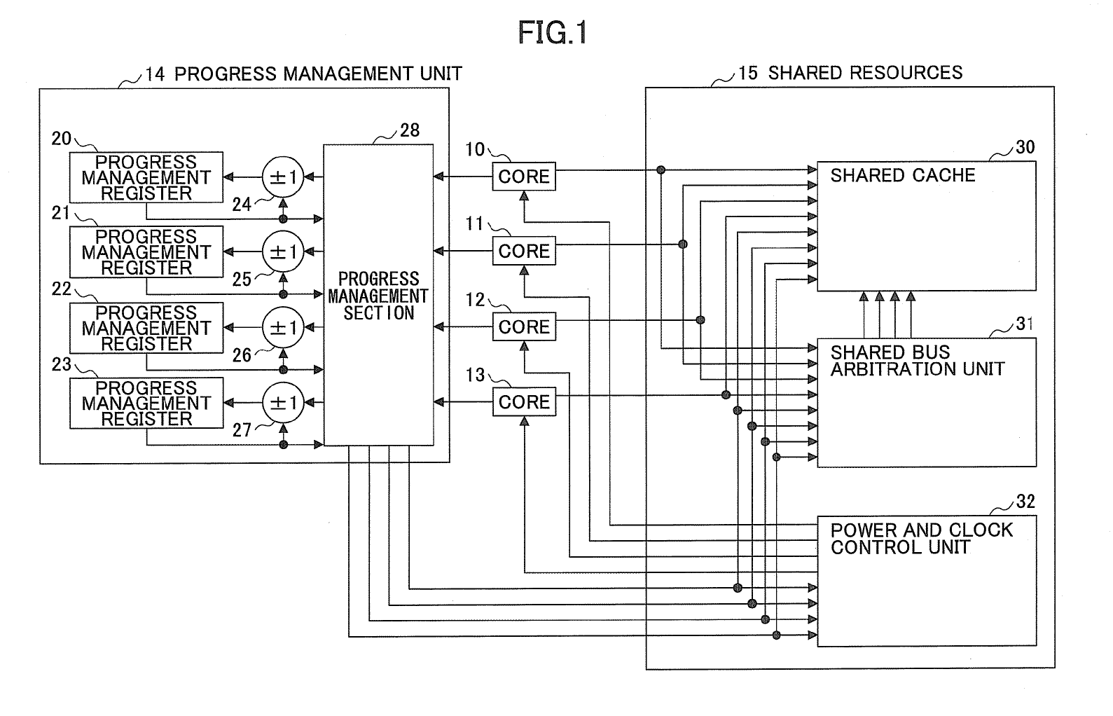

FIG. 1 is a schematic view illustrating an example of a configuration of an processor according to the present embodiment. The processor includes cores 10-13 as processing sections, a progress management unit 14, and shared resources 15. The progress management unit 14 includes progress management registers 20-23, adder-subtractors 24-27, and a progress management section 28. The shared resources 15 include a shared cache 30, a shared bus arbitration unit 31, and a power-and-clock control unit 32. Here, in FIG. 1, a boundary between a box of a function block and other function blocks basically designates a functional boundary, which may not necessarily correspond to a physical location boundary, an electrical signal boundary, a control logic boundary, or the like. Each of the function blocks may be a hardware module physically separated from the other blocks to a certain extent, or a function in a hardware module that includes functions of other blocks.

Each of the multiple cores 10-13 executes arithmetic processing. The progress management registers 20-23 are provided for the multiple cores 10-13, respectively. In the following, a location in a program at which a core progresses its execution of the program will be referred to as a “program execution location”. In FIG. 1, for each of the multiple cores 10-13, the processor changes the register value of the corresponding one of the multiple progress management registers 20-23 if the program execution location on the core reaches a predetermined location in a program. For example, if the program execution location of the core 10 reaches the predetermined location in the program, the register value of the progress management register 20 corresponding to the core 10 is, for example, increased by one. Specifically, for example, the progress management section 28 receives an indication from one of the cores 10-13 that the program execution location has reached the predetermined location in the program, reacts to the indication so that the register value of the corresponding one of the progress management registers 20-23 is incremented by the corresponding one of the adder-subtractors 24-27, and stores the incremented value into the corresponding one of the progress management register 20-23.

Executed as above, the register values stored in the progress management registers 20-23 indicate whether the program execution locations have reached the predetermined location in the program on the cores 10-13. If multiple predetermined locations are specified or a single predetermined location is passed by the program execution location multiple times, the register values stored in the progress management registers 20-23 indicate how many of the multiple predetermined locations have been reached, or how many times the single predetermined location has been reached by the program execution location. Therefore, it is possible to determine a progress state of program execution based on the register values stored in the progress management registers 20-23.

In response to changes of the register values stored in the progress management registers 20-23, namely, in response to the progress state of program execution, the progress management section changes priorities of the multiple cores 10-13. A method for changing the priorities will be described later. By changing the priorities of the multiple cores 10-13, a core whose progress of program execution is slow may be set with a relatively high priority. Similarly, a core whose progress of program execution is fast may be set with a relatively low priority. The multiple cores 10-13 share the shared resources 15. For example, a core with the first priority value may be allocated with the shared resources 15 prior to another core with the second priority value that is lower than the first priority value. Here, the shared resources 15 to be allocated include a cache memory of the shared cache 30, a bus managed by the shared bus arbitration unit 31, a shared power source managed by the power-and-clock control unit 32, etc.

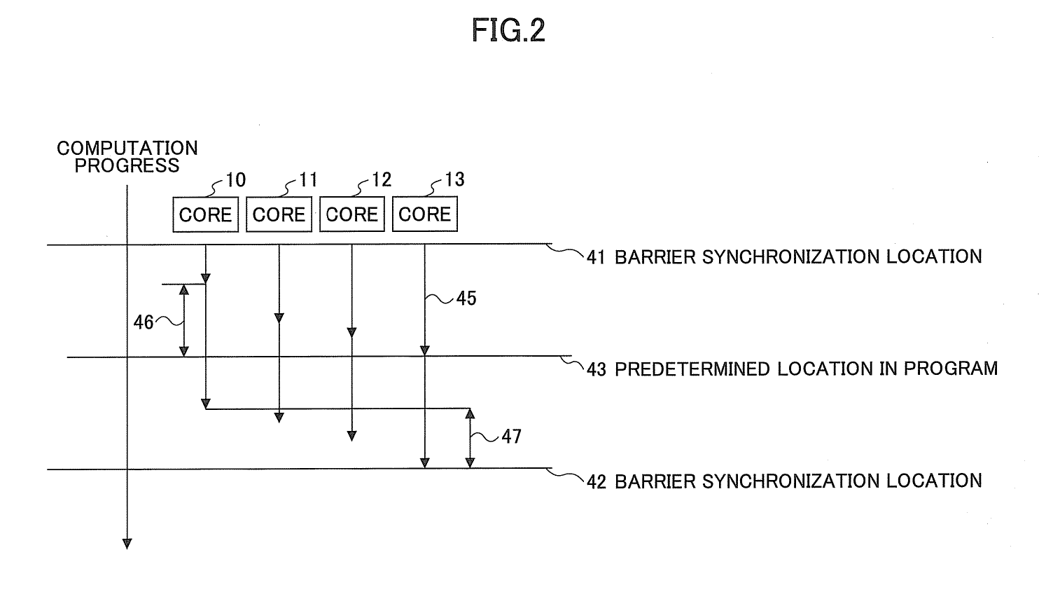

FIG. 2 is a schematic view illustrating reduction of a progress variation by setting priority based on the register values in the progress management registers 20-23. FIG. 2 illustrates that the program execution locations proceed with program execution on the multiple cores 10-13. A barrier synchronization location 41 is a location where a barrier synchronization instruction is inserted for each program, at which program execution on each of the cores 10-13 starts or resumes. Another barrier synchronization location is a location where a next barrier synchronization instruction is inserted for each program, at which the next synchronization among the cores 10-13 is established. A predetermined location in program 43 is a location where the register values of the progress management registers 20-23 are changed when the program execution location reaches the predetermined location. The predetermined location in program 43 may be, for example, a location of a specific instruction inserted in a program executed by each of the cores 10-13. The specific instruction is located at an appropriate location between the barrier synchronization location 41 and the barrier synchronization location 42. If contents of multiple programs executed on the multiple cores 10-13 are substantially the same or corresponding to each other, the specific instructions may be located at substantially the same or corresponding locations in the programs. If contents of multiple programs are different from each other, the specific instructions may be located at a location between the barrier synchronization location 41 and the barrier synchronization location 42, where the amounts of program progress are equivalent.

In the example in FIG. 2, the core 13 first reaches the predetermined location in program 43, as designated by an arrow 45. At this moment, progress difference of program execution between the fastest core 13 and the slowest core 10 is designated by the length of an arrow 46. When the program execution location on the core 13 reaches the predetermined location in program 43, the register value of the progress management register corresponding to the core 13 is, for example, increased by one. Here, the register values of the multiple progress management registers 20-23 may be 0 at an initial state. If the register value of the progress management register 23 becomes greater than the register values of the other progress management registers 20-22, the progress management section 28 determines that the program execution on the core 13 progresses ahead of the other program execution on the other cores 10-12, to lower the priority of the core 13. Specifically, based on an indication by the progress management section 28 (for example, an indication of priority information designating the priorities of the cores), a resource control section of the shared resources 15 gives priorities to the other cores 10-12 over the core 13. Here, the resource control section of the shared resources 15 may be, for example, a cache control section of the shared cache 30, the shared bus arbitration unit 31, the power-and-clock control unit 32, or the like.

By lowering the priority of the core 13 as above, the program progress on the core 13 slows down. As a result, when the program execution location on the core 13 reaches the barrier synchronization location 42, the progress difference of the program execution between the fastest core 13 and the slowest core 10 is reduced to an amount designated by the length of an arrow 47. The amount is sufficiently small when compared with the progress difference of the program execution designated by the arrow 46, which is obtained in a state without the priority adjustment. Here, if no priority adjustment were taken, a progress difference that would amount to twice as long as the length of the arrow 46 would be generated between the fastest core 13 and the slowest core 10 when the program execution location on the core 13 reached the barrier synchronization location 42.

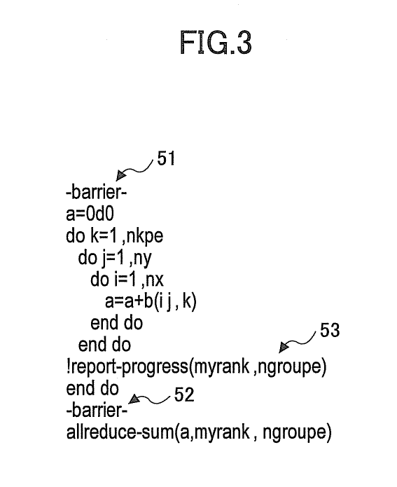

FIG. 3 is an example of a program executed by the cores 10-13. In this example, each of the cores 10-13 executes the same program in FIG. 3. By running the program on each of the cores 10-13, each of cores 10-13 calculates a sum “a” of values in an array “b”, which is summed up by the last command “allreduce-sum”. An instruction 51 in the program is the first barrier synchronization instruction. The location of the barrier synchronization instruction 51 corresponds to the location of the barrier synchronization location 41 in FIG. 2. An instruction 52 in the program is the second barrier synchronization instruction. The location of the barrier synchronization instruction 52 corresponds to the location of the barrier synchronization location 42 in FIG. 2. An instruction 53 is a report-progress instruction for indicating to the progress management unit 14 that the program execution location reaches a predetermined location. The location of the report-progress instruction 53 corresponds to the location of the predetermined location in program 43.

A parameter of the report-progress instruction 53, “myrank”, represents the core number on which the program is running. For example, in the program running on the core 10, the parameter “myrank” is set to 0. For example, in the program running on the core 11, the parameter “myrank” is set to 1. For example, in the program running on the core 12, the parameter “myrank” is set to 2. For example, in the program running on the core 13, the parameter “myrank” is set to 3. Another parameter “ngroupe” represents a group in which the core, on which the program is running, is included. For example, the cores 10-13 may be partitioned into the first group that includes the cores 10 and 11, and the second group that includes the cores 12 and 13 so that progress variations may be independently adjusted within the respective groups. Namely, in the first group, priorities may be adjusted so that the faster one of the core 10 and the core 11 is made slower, and in the second group, priorities may be adjusted so that the faster one of the core 12 and the core 13 is made slower. Alternatively, the parameter “ngroupe” is set to make a single group so that all of the cores 10-13 are included in the group, hence the priorities of the cores may be adjusted among the cores 10-13 depending on their relative progress.

If the report-progress instruction 53 is executed on one of the cores 10-13, the parameters “myrank” and “ngroupe” are indicated to the progress management section 28 by the core. In response to the indication, the progress management section 28 changes the register value of the corresponding progress management register designated by the parameter “myrank” (for example, increase the register value by one). Thus, the multiple cores 10-13 change the register values of the respective progress management registers 20-23 when executing a prescribed command inserted in a predetermined location in program. The progress management section 28 may change priorities based on a group partitioning designated by the parameter “ngroupe” when changing the priorities based on the register values of the progress management registers 20-23.

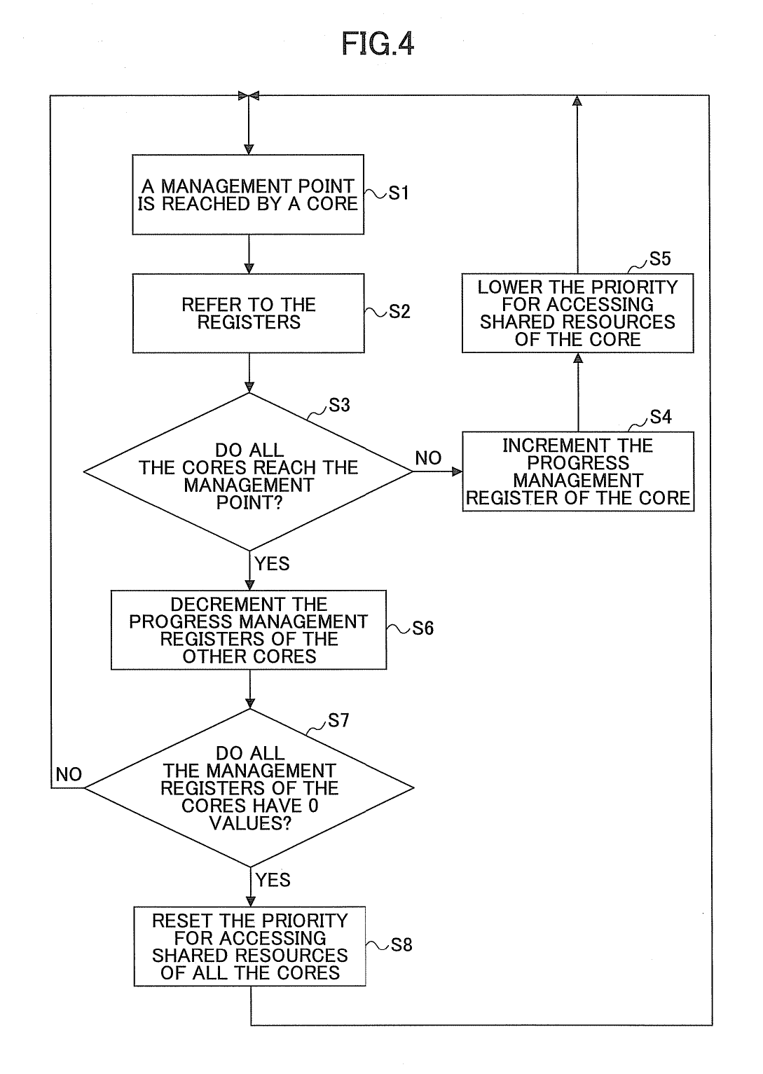

FIG. 4 is a flowchart illustrating an example of an operation of the processor in FIG. 1. At Step S1, the program execution location on a core reaches a management point (namely, a predetermined location in program). The core sends a report to the progress management section 28 that the core reaches the management point.

At Step S2, the progress management section 28 refers to the progress management registers 20-23 to check the register values. At Step S3, the progress management section 28 determines whether all the cores other than the one that reaches the management point this time have reached the management point. Namely, it is determined whether the core that reaches the management point this time is the slowest progressing core. If it is not the case that all the cores other than the one that reaches the management point this time have already reached the management point, namely, the core that reaches the management point this time is not the slowest progressing core, the progress management register of the core is increased by one at Step S4. At following Step S5, the progress management section makes a necessary indication (for example, priority information designating the priorities of the cores) to the shared resources 15 so that the priority of the core for accessing the shared resources 15 is lowered.

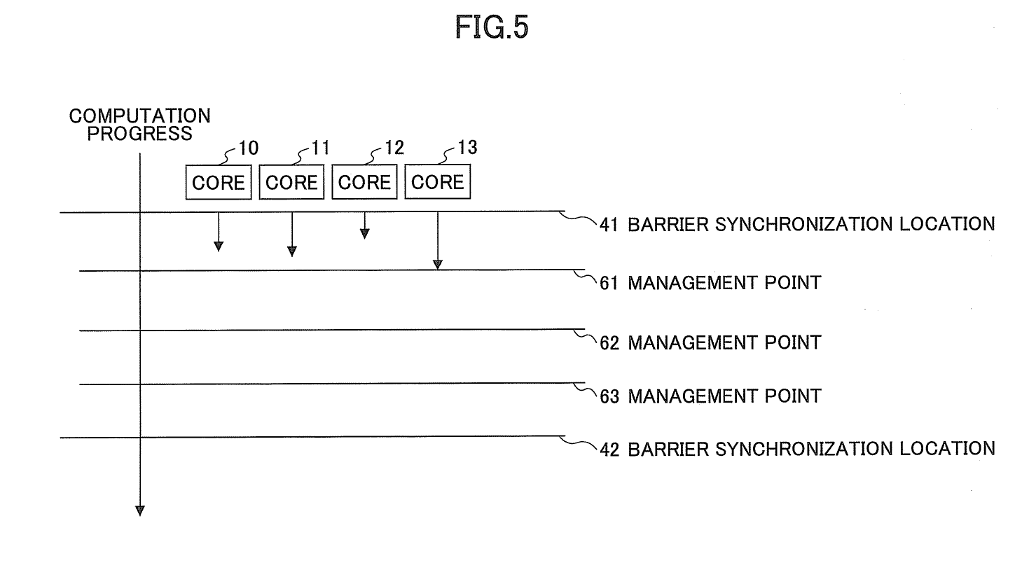

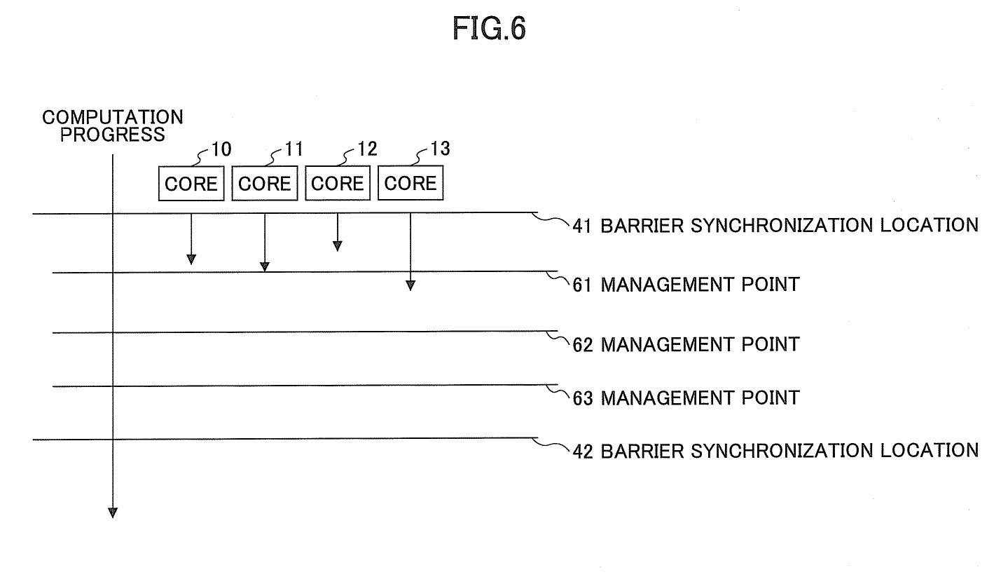

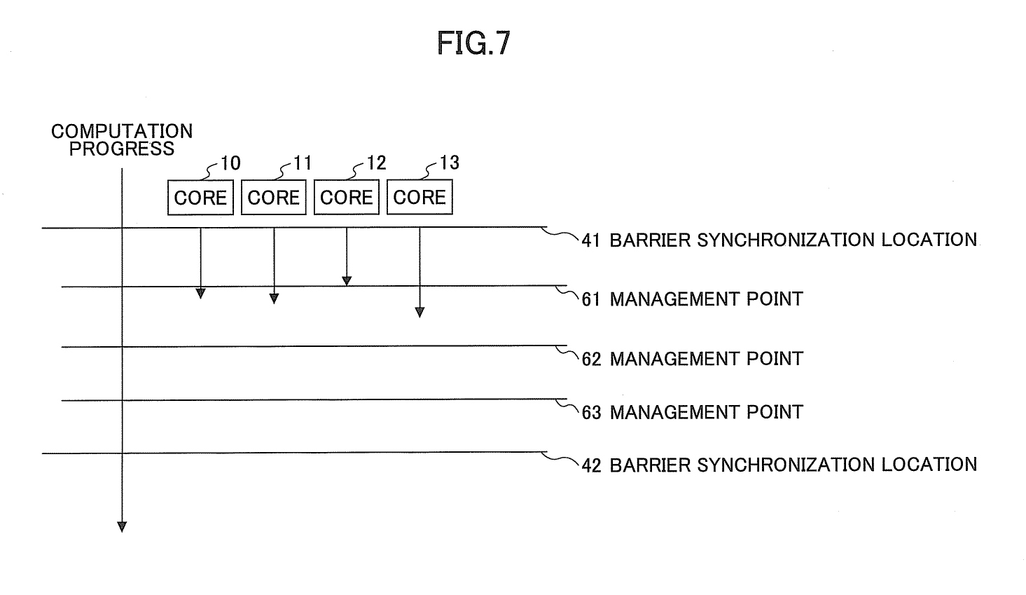

FIG. 5 is a schematic view illustrating an example of a state in which a fastest core reaches the first management point. FIG. 6 is a schematic view illustrating an example of a state in which a second fastest core reaches the first management point. FIG. 7 is a schematic view illustrating an example of a state in which a slowest core reaches the first management point. In these examples, the barrier synchronization locations 41 and 42 are the same as the ones illustrated in FIG. 2. In these examples, three management points 61-63 are set as three predetermined locations in program. The core 13 first reaches the first management point 61, the core 11 reaches the first management point 61 next, and the core 12 reaches the first management point 61 last.

In the example in FIG. 5, the core 13 that reaches the first management point 61 is not the slowest progressing core, hence the progress management register 23 of the core 13 is increased by one at Step S4. At following Step S5, to lower the priority of the core 13 for accessing the shared resources 15, the necessary indication is sent to the shared resources 15. In the example in FIG. 6, the core 11 that reaches the first management point is not the slowest progressing core, hence the progress management register 23 of the core 11 is increased by one, which lowers the priority of the core 11 for accessing the shared resources 15.

Referring to FIG. 4 again, if, at Step 3, all the cores other than the one that reaches the management point this time have already reached the management point, namely, the core that reaches the management point this time is the slowest core, Step S6 is executed. At Step S6, the progress management registers of the cores other than the one that reaches the management point this time are decreased by one. As described above, when the program execution on a core reaches the predetermined location in the program, if the core is not the slowest core, the register value of the progress management register corresponding to the core is increased by a predetermined value (1 in this example). However, if the core turns out to be the slowest core at Step S3, the register value of the progress management registers corresponding to the other cores may be decreased by a predetermined value (1 in this example).

This decrement operation at the Step 6 is not necessarily required, but the operation has an effect that the register value of the slowest core can be always kept at 0 by decrementing the register values of the relevant progress management registers as above when all of the cores have reached the management point. Therefore, it is possible to determine how much progress has been made on a core just based on the register value of the progress management register corresponding to the core, without comparing the register values with the other registers. It is also possible to determine whether the other cores have reached the management point by determining whether the progress management registers of the other cores all have one or greater values.

In the example in FIG. 7, the core 12 that reaches the first management point 61 is the slowest progressing core, hence the progress management registers 20, 21 and 23 of the cores 10, and 13, respectively, are decreased by one at Step S6. The register value of the progress management register 22 of the slowest progressing core 12 remains 0.

Referring to FIG. 4 again, at Step S7, the progress management section 28 determines whether the values of the progress management registers of all the cores are 0. If the values of the progress management registers of all the cores are 0, access priorities of all the cores to the shared resources 15 are reset to an initial state of the access priorities at Step S8. Namely, at the moment when the slowest core reaches a management point, if none of the other cores have yet reached the next management point, the access priorities are reset to the initial state based on a determination that progress difference among the cores may be sufficiently small. At the initial state, all the cores may have, for example, the same access priority, or no priority.

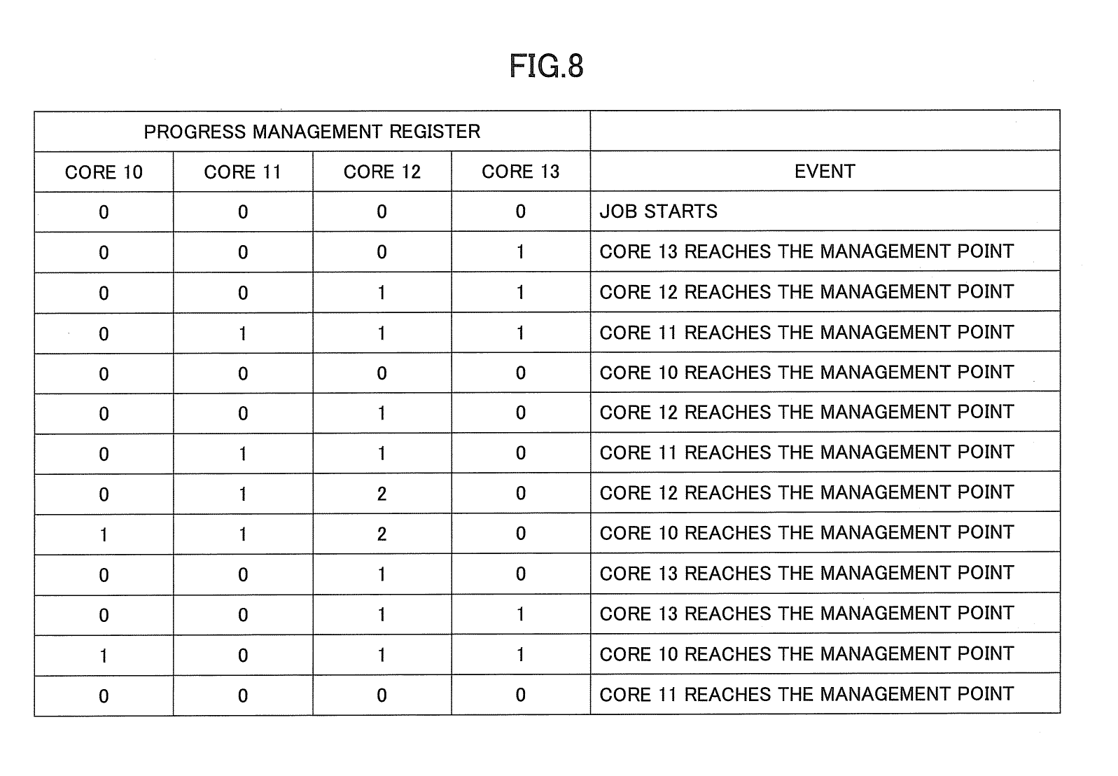

FIG. 8 is a schematic view illustrating an example of changes of register values in the progress management registers 20-23. First, the core 13 reaches the management point, which makes the progress management register corresponding to the core 13 change from 0 to 1. Next, the core 12 reaches the management point, which makes the progress management register corresponding to the core 12 change from 0 to 1. Next, the core 11 reaches the management point, which makes the progress management register corresponding to the core 11 change from 0 to 1. Next, when the core 10 reaches the management point, the progress management registers corresponding to the other cores 11-13 are decreased from 1 to 0, because the other cores have already reached the management point. Namely, the values of all the progress management registers for the cores 10-13 are set to 0.

After that, when the core 12, the core 11, the core 12, and the core 10 reach the management point in this order, the progress management registers for the cores 10-13 take values 1, 1, 2, and 0, respectively. If the core 13 reaches the management point at this moment, the progress management registers corresponding to the cores 10-12 are decreased by one because the cores other than 13, namely 10-12, have already reached the management point. Consequently, the progress management registers for the cores 10-13 take values 0, 0, 1, and 0, respectively.

Based on such changes of register values of the progress management registers 20-23 as illustrated above, the progress management section 28 sends an indication for adjusting priorities (for example, an indication of priority information designating the priorities of the cores) to the shared resources 15 as described with reference to FIG. 2. In response to the indication, the resource control section of the shared resources 15 adjusts shared resource allocation. Here, the resource control section of the shared resources 15 may be, for example, the cache control section of the shared cache 30, the shared bus arbitration unit 31, the power-and-clock control unit 32, or the like.

First, shared resource allocation by the power-and-clock control unit 32 will be described. In general, power consumption and operating frequency have a close relationship in a core. To increase execution speed of a core by increasing the operating frequency, it is preferable to raise power-supply voltage, although the power consumption of the core increases accordingly. In this case, an upper limit may be set for power used by a processor from the view points of heat radiation, environmental issues, cost, and the like. When setting the upper limit for power, frequency and power may be considered as shared resources of cores. By adjusting distribution of limited power based on the priorities of the cores, the frequency of a slowly progressing core may be relatively raised, whereas the frequency of a fast progressing core may be relatively lowered.

Namely, as illustrated in FIG. 1, the power-and-clock control unit 32 receives priority information from the progress management section 28 that indicates the priorities of the cores. Based on the priority information, the power-and-clock control unit 32 changes the power-supply voltage and clock frequency fed to the cores 10-13. At this moment, the progress management section 28 may make a request for changing the power-supply voltage and clock frequency to the power-and-clock control unit 32. The power-and-clock control unit 32 may reduce the power-supply voltage and clock frequency for a fast progressing core that has a low priority. Similarly, the power-and-clock control unit 32 may raise the power-supply voltage and clock frequency for a slowly progressing core that has a high priority.

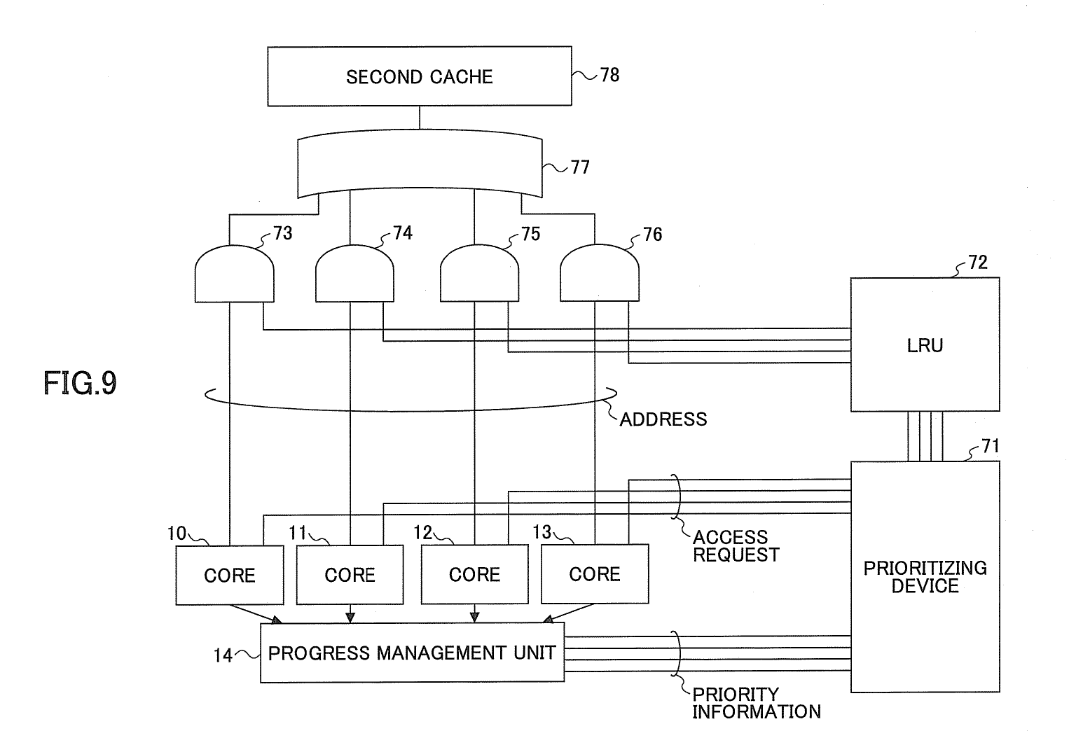

FIG. 9 is a schematic view illustrating an example of a shared resource allocation mechanism in the shared bus arbitration unit 31. In FIG. 9, the cores 10-13, the progress management unit 14, a prioritizing device 71, an LRU unit 72, AND circuits 73-76, an OR circuit 77, and a second cache 78 are illustrated. The shared bus arbitration unit 31 in FIG. 1 may include the prioritizing device 71 and the LRU unit 72, and the shared cache 30 in FIG. 1 may include the AND circuits 73-76, the OR circuit 77, and the second cache 78. Here, the prioritizing device 71 may be included in the progress management unit 14 instead of the shared bus arbitration unit 31.

A first cache is built into each of the cores 10-13. The second cache 78 exists between an external memory device and the first cache in memory hierarchy. If a cache miss occurs when accessing the first cache, the second cache 78 is accessed. The LRU unit 72 holds information about which core is a LRU (Least Recently Used) core, which is a core that has the longest time passed since the last access to the second cache 78, among the multiple cores 10-13. If no specific priorities are set on the cores 10-13, the LRU unit 72 gives a grant to access a bus connected with the second cache 78 to the LRU core over the other cores. The bus is the part where the output of the OR circuit 77 is connected. Specifically, for example, if the core is the LRU core, and the core 11 outputs an accessing address and asserts an access request signal to make a request for access permission, the LRU unit 72 sets the value 1 on a signal connected with an input of the corresponding AND circuit 74 to grant the access. Namely, the address signal output from the access-granted core 11 is fed to the second cache 78 via the AND circuit 74 and the OR circuit 77. If another core tries to access the second cache 78 when the core 11 asserts the access request signal, the other core cannot access the second cache 78 because the priority is given to the core 11, or the LRU core. Namely, when receiving an access request signal from the core 10, 12, or 13 other than the LRU core 11, the LRU unit 72 holds the value 0 on the signals connected with the corresponding AND circuits 73, 75, and 76.

If the progress management unit 14 sets priorities on the cores 10-13, the prioritizing device 71 adjusts access permission behavior of the LRU unit 72. Specifically, the prioritizing device receives priority information about the priorities of the cores 10-13 from the progress management unit 14, then based on the priority information, cuts off access request signals to the LRU unit 72 from cores with relatively low priorities. Namely, although the access request signals from the cores 10-13 are usually fed to the LRU unit 72 via the prioritizing device 71, the access request signals from the cores with relatively low priorities are cut off by the prioritizing device 71, not to be fed to the LRU unit 72.

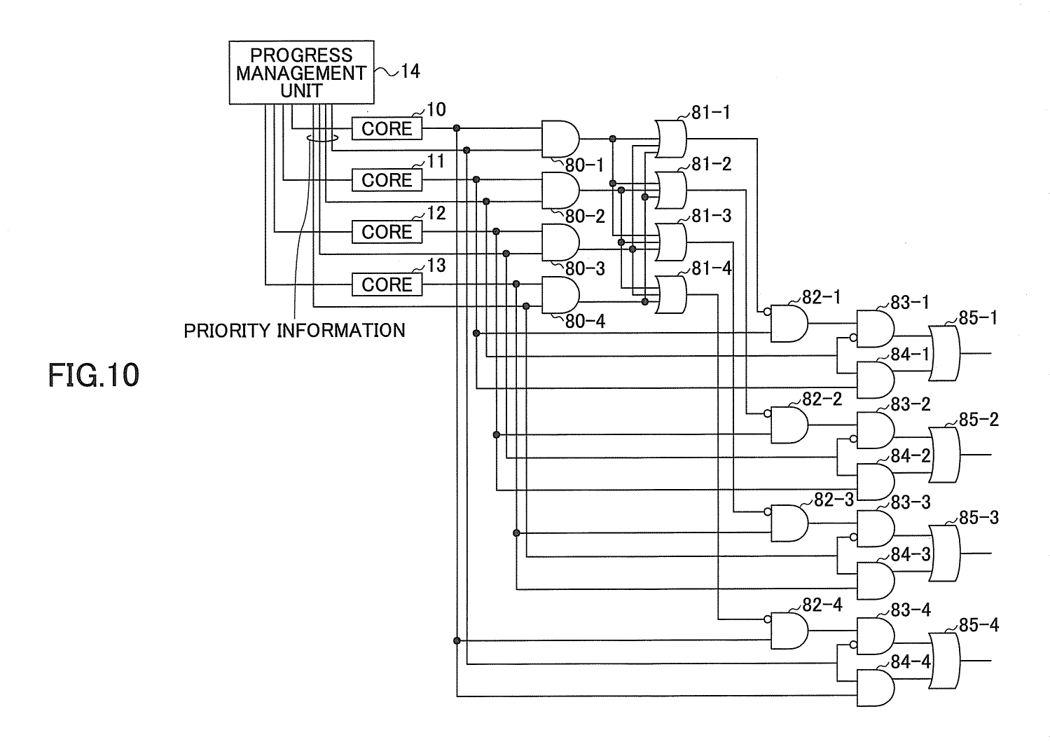

FIG. 10 is a schematic view illustrating an example of a configuration of the prioritizing device 71. The prioritizing device 71 includes AND circuits 80-1 to 80-4, OR circuits 81-1 to 81-4, two-input AND circuits 82-1 to 82-4 and 83-1 to 83-4 that have one negated input, AND circuits 84-1 to 84-4, and OR circuits 85-1 to 85-4. The progress management unit 14 feeds a signal to the first inputs of the AND circuits 80-1 to 80-4, which takes if the register value of the progress management register is 0, otherwise takes 0. The priority information on the signal is also fed to the first inputs of the AND circuits 83-1 to 83-4 and the AND circuits 84-1 to 84-4. For example, if priority information is 0 for the core 10, then the value of the progress management register 20 for the core 10 is 1 or greater, which indicates that the core 10 progresses relatively ahead of the other cores, hence the priority of the core 10 is set low. Also, for example, if priority information is 1 for the core 10, then the value of the progress management register 20 for the core 10 is 0, which indicates that the core 10 progresses relatively behind, hence the priority of the core 10 is set high.

The cores 10-13 assert the access request signals to 1 when making a request of access, which are fed to the second input of the AND circuits 80-1 to 80-4, respectively. These access request signals are also fed to the first inputs of the AND circuits 82-1 to 82-4 and the second inputs of the AND circuits 84-1 to 84-4. The outputs of the AND circuits 82-1 to 82-4 are fed to the second inputs of the AND circuits 83-1 to 83-4, respectively.

Focusing on, for example, the AND circuits 83-4 and 84-4 that are fed with the priority information of the core 10, if the priority information of the core 10 is 1 (namely, a high priority), the access request signal from the core 10 passes through the AND circuit 84-4. Namely, if the priority information of the core 10 is 1 (namely, a high priority), the access request signal from the core 10 passes through the AND circuit 84-4 to be output from the prioritizing device 71 via the OR circuit 85-4. The output signal is fed to the LRU unit 72 via the prioritizing device 71.

On the contrary, if the priority information of the core 10 is 0 (namely, a low priority), the access request signal from the core passes through the AND circuit 83-4. In this case, however, the access request signal passes through the AND circuit 82-4 and the AND circuit 83-4 to be output from the prioritizing device 71 via the OR circuit 85-4 only if a predetermined condition implemented with the AND circuits 80-2 to 80-4 and the OR circuit 81-4 is satisfied. The output signal is fed to the LRU unit 72 via the prioritizing device 71.

The AND circuits 80-1 to 80-4 take the output value of 1 only if the cores 10-13 assert the access request signals and have a high priority, respectively. The OR circuit 81-4 outputs a result of OR operation on the outputs of the AND circuits 80-2 to 80-4. Therefore, the output of the OR circuit 81-4 is 1 if at least one of the cores with a high priority other than the core 10 asserts the access request signal; otherwise, the output of the OR circuit 81-4 is 0.

Therefore, if the priority of the core 10 is low, and at least one of the cores other than the core 10 with a high priority asserts the access request signal, the access request signal asserted by the core 10 is not supplied to the LRU unit 72. If the priority of the core 10 is low, the access request signal asserted by the core 10 is supplied to the LRU unit 72 only if none of the cores other than the core 10 with a high priority assert the access request signal.

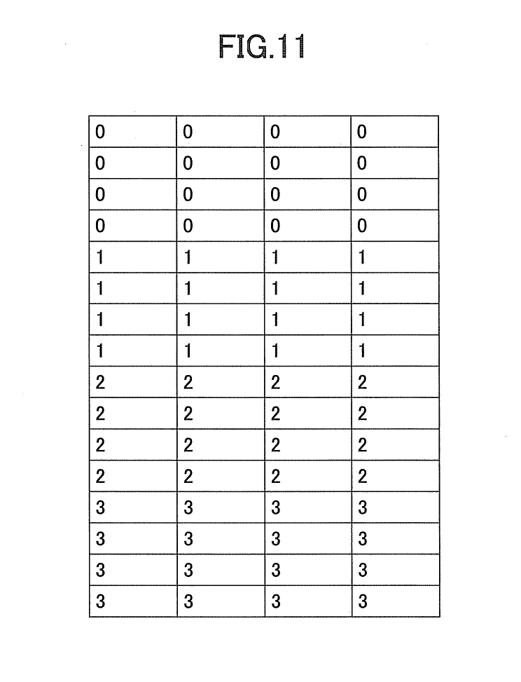

FIGS. 11-14 are schematic views illustrating examples of cache way allocation based on priority. The shared cache 30 may allocate the cache ways based on priority information from the progress management section 28. The multiple cores 10-13 can access the shared cache 30, which is the second cache provided separately from the dedicated first cache in each core. When accessing the cache, a cache miss may occur due to a conflict among the cores 10-13 depending on usage of the cache ways, which are shared resources of the shared cache 30. The number of cache misses due to the conflict tends to increase when the number of cores increases. To make cache misses due to the conflict occur less frequently, dynamic partitioning of the cache ways among cores may be introduced. In such dynamic partitioning, way partitioning may be adjusted based on the priorities of the cores so that a slowly progressing core may be prioritized when assigning ways.

In the following, an example of way partitioning of the shared cache 30 will be explained, which is based on priority information from the progress management unit 14 illustrated in FIG. 1. Here, it is assumed that the number of ways (the number of tags corresponding to each index) is 16.

In FIGS. 11-14, vertically arranged 16 rows represent 16 ways, and horizontally arranged four columns represent four indices. If the cores 10-13 have the same progress status, each of the cores 10-13 may occupy four ways as illustrated in FIG. 11. Here, “0” designates a way to be occupied by the core 10, “1” designates a way to be occupied by the core 11, “2” designates a way to be occupied by the core 12, and “3” designates a way to be occupied by the core 13.

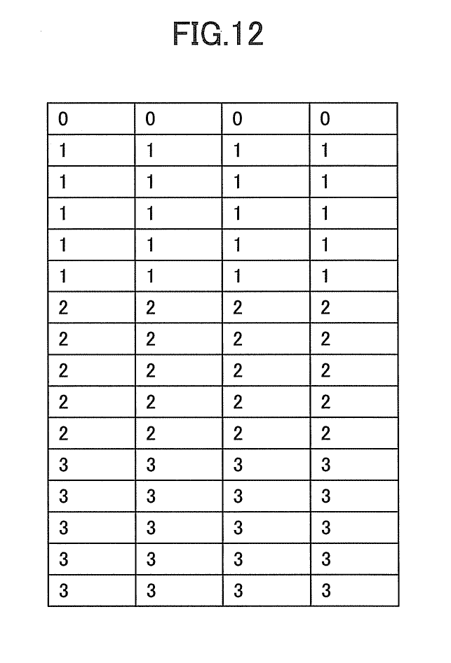

For example, if the core 10 progresses ahead and the other cores 11-13 are left behind, the ways may be dynamically partitioned in the shared cache 30 so that the core 10 occupies one way, whereas the other cores 11-13 occupy five ways, respectively, as illustrated in FIG. 12.

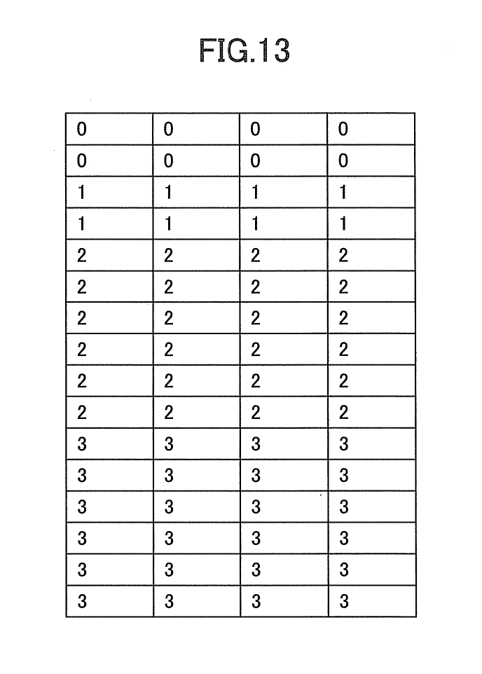

Also, for example, if the cores 10-11 progress ahead and the other cores 12-13 are left behind, the ways may be dynamically partitioned in the shared cache 30 so that the cores 10-11 occupy two ways, respectively, whereas the other cores 12-13 each occupy six ways as illustrated in FIG. 13.

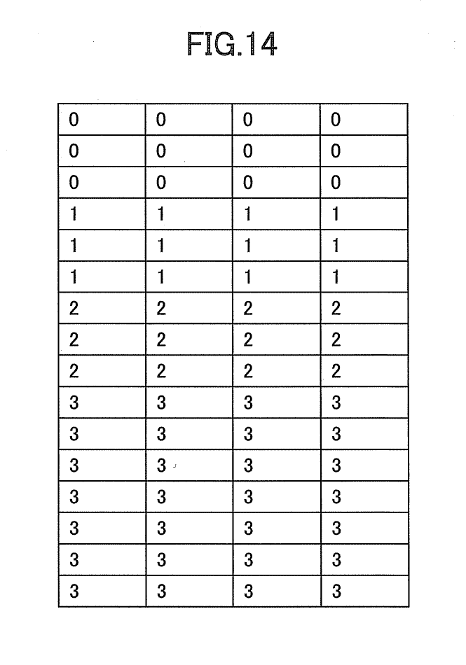

Also, for example, if the cores 10-12 progress ahead and the other core 13 is left behind, the ways may be dynamically partitioned in the shared cache 30 so that the cores 10-12 occupy three ways, respectively, whereas the other core 13 occupies seven ways, which is illustrated in FIG. 14.

The above examples are provided just for explanation, and bear no intention to limit the present embodiment. Various way partitioning schemes other than the above are possible.

An processor has been described above with preferred embodiments. The present invention, however, is not limited to these embodiments, but various variations and modifications may be made without departing from the scope of the present invention.

For example, although rewriting of the register values of the progress management registers 20-23 and priority adjustment are described with examples in which centralized control is executed by the progress management section 28, these operations may be executed by the cores 10-13 with distributed control. For example, the cores 10-13 may directly rewrite the register values of the progress management registers 20-23 by executing a predetermined instruction. Also, the cores 10-13 may make requests to control sections of the shared resources 25 for lowering priorities of themselves by referring to the register values of the progress management registers 20-23.

Also, synchronization may be established with any synchronization mechanism other than the barrier synchronization. Also, the number of progress management points (predetermined locations in program) between synchronization locations may be one or more. Also, one or more predetermined locations may be set between the beginning and the end of a program without setting any synchronization locations.

All examples and conditional language recited herein are intended for pedagogical purposes to aid the reader in understanding the invention and the concepts contributed by the inventor to further the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. An processor comprising:
a plurality of arithmetic processing sections to execute arithmetic processing; and
a plurality of registers provided for the plurality of arithmetic processing sections,
wherein for each of the plurality of arithmetic processing sections, a register value of a register of the plurality of registers corresponding to a given one of the plurality of arithmetic processing sections is changed if program execution by the given one of the plurality of arithmetic processing sections reaches a predetermined location in a program, and
wherein priorities of the arithmetic processing sections are dynamically determined in response to register values of the registers.

2. The processor as claimed in claim 1, wherein for each of the plurality of arithmetic processing sections, a register value of a register of the plurality of registers corresponding to a given one of the plurality of arithmetic processing sections is changed if a predetermined command inserted at a predetermined location in the program is executed.

3. The processor as claimed in claim 1, wherein when the program execution by one of the plurality of arithmetic processing sections reaches the predetermined location in the program, the register value of one of the plurality of registers corresponding to the one of the plurality of arithmetic processing sections is increased by a predetermined amount if the one of the plurality of arithmetic processing sections is not a slowest arithmetic processing section, and the register values of the plurality of registers corresponding to the plurality of arithmetic processing sections other than the one of the plurality of arithmetic processing sections are decreased by a predetermined amount if the one of the plurality of arithmetic processing sections is the slowest arithmetic processing section.

4. The processor as claimed in claim 1, wherein the plurality of arithmetic processing sections share a shared resource,
wherein one of the plurality of arithmetic processing sections having a first priority value is prioritized over another one of the arithmetic processing sections having a second priority value lower than the first priority value, when the shared resource is being allocated.

5. The processor as claimed in claim 4, wherein the shared resource is at least one of a cache, a shared bus, and a shared power supply.

6. A method for arithmetic processing comprising:
executing arithmetic processing on a plurality of arithmetic processing sections;
changing a register value of one of a plurality of registers corresponding to a given one of the plurality of arithmetic processing sections if program execution by the given one of the plurality of arithmetic processing sections reaches a predetermined location in a program; and
dynamically determining priorities of the arithmetic processing sections in response to register values of the registers.
